(19) United States
(12) Patent Application Publication
(10) Pub. No.: US 2015/0163752 A1
(43) Pub. Date: Jun. 11, 2015

(54) METHOD AND APPARATUS FOR MITIGATING INTERFERENCE IN USER EQUIPMENT

(71) Applicant: Samsung Electronics Co., Ltd., Gyeonggi-do (KR)

(72) Inventor: Ian K. APPLETON, Letchworth Garden City (GB)

(73) Assignee: Samsung Electronics Co., Ltd.

(21) Appl. No.: 14/327,980

(22) Filed: Jul. 10, 2014

Related U.S. Application Data
(60) Provisional application No. 61/914,169, filed on Dec. 10, 2013.

(51) Int. Cl. H04W 52/24; H04W 72/02; H04W 52/28

(52) U.S. Cl. CPC H04W 52/243; H04W 52/286; H04W 52/245; H04W 72/02; H04W 52/241; H04W 88/06

(57) ABSTRACT

A method and apparatus for mitigating interference in A User Equipment (UE) is provided. The UE includes a Long Term Evolution (LTE) modem including a LTE transmitter and a Wireless Local Area Network (WLAN) station. The WLAN station is in communication with the LTE modem via a Coexistence Interface (CoI) which receives notification signals from the LTE modem indicating when the LTE transmitter is active and inactive. The notification signals and local context information associated with the WLAN station are correlated for generating a power control signal that is transmitted from the WLAN station to the LTE modem for controlling a power level of LTE transmissions.

### PRIORITY

The present invention claims priority to U.S. Provisional Application Ser. No. 61/914,169, which was filed in the United States Patent and Trademark Office on Dec. 10, 2013, the entire disclosure of which is incorporated herein by reference.

### BACKGROUND OF THE INVENTION

1. Field of the Invention

The present invention relates generally to a method and apparatus for mitigating interference in User Equipments (UEs), and more particularly, to a method and apparatus for mitigating interference between a Long Term Evolution (LTE) modem and Wireless Local Area Network (WLAN) station in a UE by reducing LTE transmitted power levels.

2. Description of the Related Art

Coexistence interference between LTE modems and WLAN stations in UEs is an issue in cases where an LTE transmitter and a WLAN receiver are both active on adjacent bands (e.g., a collocated LTE modem and WLAN station). Such interference can result in performance degradation of the UE.

The amount of interference can depend on parameters such as a power level of the LTE transmitter, a frequency of the LTE transmitter relative to the WLAN receiver, a bandwidth of the signal being transmitted, and coupling between the LTE antenna(s) and the WLAN antenna(s). The coupling can vary depending on proximity of the antennas to other objects and is often difficult to measure directly.

Various strategies have been used to mitigate coexistence interference between a collocated LTE modem and WLAN station. For example, disabling the WLAN station during LTE reception and transmission times (e.g., time-slice LTE and WLAN operation) or requesting a WLAN channel or LTE network channel change have been used to mitigate the coexistence interference between a collocated LTE modem and WLAN station.

However, such strategies have shortcomings. For example, disabling the WLAN station can disrupt packet reception, which can be quite heavy at times, by as much as ninety percent. Further, changing WLAN station/LTE modem channels, i.e., changing local Access Point (AP) channels, is difficult as it requires the AP to be brought down and back up on a new channel, thereby interrupting ongoing traffic.

Thus, there is a need for UE interference mitigation methods and apparatuses which can effectively mitigate coexistence interference between a collocated LTE modem and WLAN station without disabling the WLAN station and/or changing WLAN station/LTE channels.

### SUMMARY OF THE INVENTION

The present invention has been made to address the above problems and disadvantages, and to provide at least the advantages described below. Accordingly, an aspect of the present invention is to provide a method and apparatus for mitigating interference between an LTE modem and a WLAN station in UEs by reducing LTE transmitted power levels.

According to an aspect of the present invention, a UE is provided. The UE includes an LTE modem including an LTE transmitter and a WLAN station. The WLAN station is in communication with the LTE modem via a Coexistence Interface (CoI) which receives notification signals from the LTE modem indicating when the LTE transmitter is active and inactive. The notification signals and local context information associated with the WLAN station are correlated for generating a power control signal that is transmitted from the WLAN station to the LTE modem for controlling a power level of LTE transmissions.

According to another aspect of the present invention, a method for mitigating coexistence interference in a User Equipment (UE) including an LTE modem and a WLAN station is provided. The method includes generating from an LTE transmitter of the LTE modem notification signals indicating when the LTE transmitter is active and inactive. Thereafter, notification signals are transmitted to a WLAN station. The notification signals are then correlated with local context information associated with the WLAN station. Next, a power control signal based on the correlation is generated, and the power control signal is transmitted from the WLAN station to the LTE modem for controlling a power level of LTE transmissions.

According to another aspect of the present invention, a User Equipment (UE) is provided. The UE includes a Wireless Local Area Network (WLAN) station including a WLAN modem and a WLAN transreceiver. The UE includes a Long Term Evolution (LTE) modem including an LTE transreceiver. The LTE modem is in communication with the WLAN station via a Coexistence Interface (CoI) which receives notification signals from the WLAN modem indicating when the WLAN transreceiver is active and inactive. The notification signals and local context information associated with one of the LTE modem and the WLAN station are correlated for generating a power control signal that is transmitted from the LTE modem to the WLAN station for controlling a power level of WLAN transmissions.

### BRIEF DESCRIPTION OF THE DRAWING

The above and other aspects, features, and advantages of certain embodiments of the present invention will be more apparent from the following detailed description taken in conjunction with the accompanying drawings, in which:

FIG. 1 is a diagram illustrating pertinent components configured for mitigating coexistence interference in a UE including an LTE modem and a WLAN station, according to an embodiment of the present invention; and

FIG. 2 is a flowchart illustrating a method for mitigating coexistence interference in a UE including the LTE modem and the WLAN station shown in FIG. 1, according to an embodiment of the present invention.

### DETAILED DESCRIPTION OF EMBODIMENTS OF THE PRESENT INVENTION

One or more embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In view of the shortcomings associated with known strategies used to mitigate coexistence interference between a collocated LTE modem and WLAN station, a method and apparatus that mitigates interference between an LTE modem and a WLAN station in a UE by reducing LTE transmitted power levels which may prove useful in telecommunications is herein described.

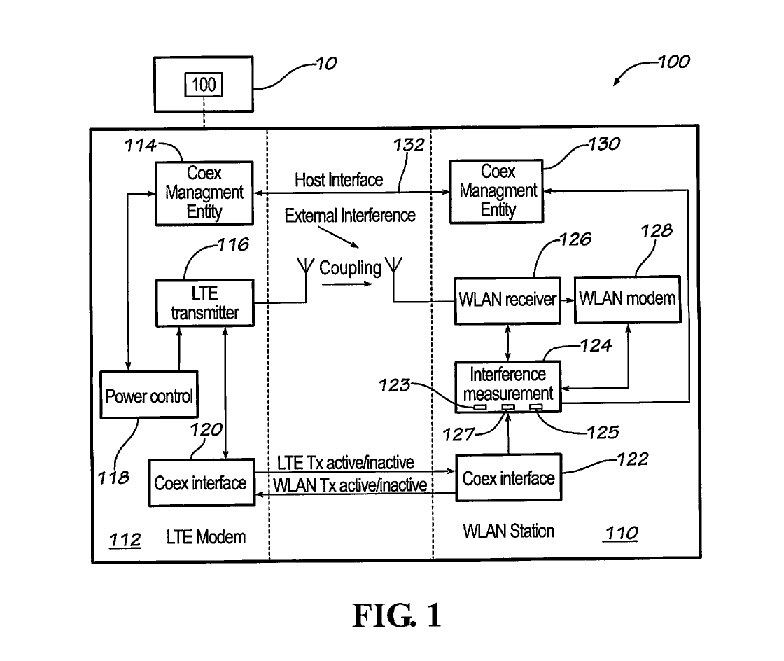

FIG. 1 is a diagram illustrating pertinent components configured for mitigating coexistence interference in UE 10 (shown schematically) including a collocated WLAN and LTE device 100 having a WLAN station 110 and LTE modem 112, according to an embodiment of the present invention.

The LTE modem 112 and the WLAN station 110 can be included within various types of UEs with wireless communication capabilities, e.g., mobile phones, notebook computer, tablet computers, portable router, gaming consoles, personal computers, etc.

In the illustrated embodiment, the LTE modem 112 and the WLAN station 110 are embodied on distinct integrated circuits (e.g., distinct LTE and WLAN chips) on a common circuit board. Alternatively, the LTE modem 112 and the WLAN station 110 can be embodied on distinct integrated circuits on separate circuit boards in close proximity to one another, or the LTE modem 112 and the WLAN station 110 can be embodied on a single integrated circuit, e.g., a System on a Chip (SoC). However, in this case a more complex and comprehensive wiring scheme may be needed to accommodate such a configuration of the LTE modem 112 and the WLAN station 110.

Continuing with reference to FIG. 1, the LTE modem 112 includes a Coexistence Management Entity 114 (CoME 114), an LTE transmitter 116, a Power Control Block 118, and a CoI 120. The LTE modem 112 may also include an LTE processing module, an LTE receiving module or the LTE transmitter 116 can be replaced with an LTE transreceiver (e.g., for receiving communication signals), and an LTE schedule information module (not shown).

In addition to the conventional functions that the LTE transmitter 116 is configured to perform, the LTE transmitter 116 generates notification signals indicating when the LTE transmitter 116 is active and inactive and communicates the notification signals to the CoI 120.

The CoI 120 communicates the notification signals to a peer CoI 122 of the WLAN station 110. While the CoIs 120, 122 are shown as separate components for illustrative purposes, the CoIs 120, 122 can be embodied as a single component.

The CoIs 120, 122 can be embodied in one or more suitable forms including, but not limited to, physical interfaces including wires connecting the LTE modem 112 to the WLAN station 110, Programmed Input/Output (PIO), a serial interface, etc. In the embodiments where the CoIs 120, 122 are embodied in the PIO scheme, the PIO scheme includes the LTE and WLAN Tx active signals as shown in FIG. 1 (or just one of the LTE and WLAN Tx active signals, e.g., from the LTE modem 112 to the WLAN station 110). In the embodiment wherein the CoIs 120, 122 are embodied in a serial interface scheme, the CoIs 120, 122 includes a serial data line in each direction to exchange the LTE and WLAN Tx activity information as well as other Coex related information. The CoIs 120, 122 can be configured to provide bi-directional (as shown in FIG. 1) or uni-directional communication between the LTE modem 112 and the WLAN station 110.

For illustrative purposes, the diagram illustrated in FIG. 1 shows the simplest implementation of a single signal being communicated in each direction between the CoIs 120, 122. The CoIs 120, 122, however, may be embodied in a more complex interface having additional capabilities. For example, the CoIs 120, 122 can be a bi-directional digital interface over which digital signals can be exchanged or can be a bi-directional message-based coexistence interface over which messages including coexistence information, e.g., transmit times of the WLAN station 110, are exchanged between the LTE modem 112 and the WLAN station 110.

After the CoI 122 receives the notification signals from the CoI 120, the CoI 122 communicates the notification signals to an Interference Measurement (IfM) block 124 of the WLAN station 110, which also includes a WLAN receiver 126, a WLAN modem 128, and a CoME 130. In the embodiments of the present invention, the WLAN station 110 can also include a WLAN transmitter (not shown), or the WLAN receiver 126 can be replaced with a WLAN transreceiver (not shown).

The WLAN receiver 126 is active according to a duty cycle for packet reception. The duty cycle of the WLAN receiver 126 may vary depending on a specific mode of the WLAN receiver 126, e.g., an idle mode or a reception mode. In accordance with the embodiments of the present invention, the WLAN receiver 126 is active for a duty cycle that is greater than actual packet reception time, i.e., to allow for packets to be detected by the WLAN receiver 126.

The WLAN modem 128 measures Signal-to-Noise Ratio (SNR) or other quality measurements, e.g., an interference level, for packets that are successfully received by the WLAN receiver 126, i.e., for packets that have passed a Cyclic Redundancy Check (CRC), or packets that are aborted. The WLAN modem 128 also measures the SNR on a header of the packet. In certain instances, the WLAN modem 128 may measure the SNR and the interference level when the WLAN receiver 126 is active and no packet has been detected. For example, during extended periods of no packet reception, it may be advantageous to estimate and control the interference levels from the LTE modem 112 so that future packet reception is possible.

The IfM block 124 receives SNR measurements from the WLAN modem 128 when packets are being received by the WLAN receiver 126 (ideally irrespective of CRC failure). The IfM block 124 also makes periodic measurements of a received noise level and/or measures a Received Signal Strength Indication (RSSI) in the WLAN receiver 126, which allows the IfM block 124 to estimate interference levels when no packets are being received.

The SNR measurements and received noise level measurements are part of local context information associated with the WLAN station 110. Other local context information associated with the WLAN station 110 may include, but is not limited to, a mode in which the WLAN receiver 126 is operating, packet reception volume, traffic volume, etc.

The IfM block 124 correlates the notification signal with the SNR measurements and the measured received noise level. In particular, when the LTE transmitter is active, the SNR measurements and measured received noise level made on the received packets are accumulated in an LTE transmitter active bin 123, and when the LTE transmitter is inactive, the SNR measurements and measured received noise level made on the received packets are accumulated in an LTE transmitter inactive bin 125.

In certain implementations of the present invention, SNR measurements and measured received noise level can be made on packets received by the WLAN receiver 126 when the LTE transmitter 116 transitions from active to inactive or vice versa. Such measurements may be accumulated in a bin 127 that is separate from the LTE transmitter active bin 123 and LTE transmitter in-active bin 125. Alternatively, such measurements can be discarded.

In accordance with embodiments of the present invention, interference caused by the LTE transmitter 116 is calculated by comparing the SNR measurements and measured received noise level in the LTE transmitter active bin 123 with the SNR measurements and measured received noise level in the LTE transmitter inactive bin 125. When SNR measurements are available for LTE active and inactive (e.g., SNR1 and SNR0, respectively) the interference is defined as the increase in noise level when the LTE transmitter 116 is active i.e. SNR1-SNR0. In another embodiment, an alternative to using SNR is to use estimated noise levels N1 and N0. In such an embodiment, the increase in noise level when the LTE transmitter 116 is active is equal to N1-N0.

In certain implementations of the present invention, the SNR measurements and measured received noise level accumulated in the bin 127 may also be used in calculating the interference caused by the LTE transmitter 116 to obtain a more accurate calculated interference.

In certain implementations of the present invention, a quality of the interference measurement may be determined by counting a number of packets in the LTE transmitter active bin 123, the number of packets in the LTE transmitter inactive bin 125, and/or the bin 127.

After the interference caused by the LTE transmitter 116 is calculated, the IfM block 124 generates a count information signal that includes the calculated interference and sends the count information signal to the CoME 130 of the WLAN station 110 for processing. The count information signal can be transmitted periodically based on a predetermined timing sequence.

In accordance with the embodiments of the present invention, the CoME 130 may process the count information signal to determine if the calculated interference was based on a sufficient number of counted packets.

If the CoME 130 determines that the calculated interference was based on a sufficient number of packets, the CoME 130 generates a power control signal and transmits the power control signal over a host Access Point (AP) 132 to the CoME 114 of the LTE modem 112. The power control signal may include information relating to the calculated interference, the count information, and/or the context information associated with the WLAN station 110.

As can be appreciated, the CoME 130 can be omitted and the IfM block 124 may be configured to perform the operations of the CoME 130.

The CoME 114 processes the power control signals and uses the information provided by the power control signal and local context information associated with the LTE modem 112 to calculate a power level of the LTE transmissions. Once the power level is calculated, the CoME 114 sends a power adjust signal to the Power Control Block 118 which then adjusts a power level of LTE transmissions generated by the LTE transmitter 116.

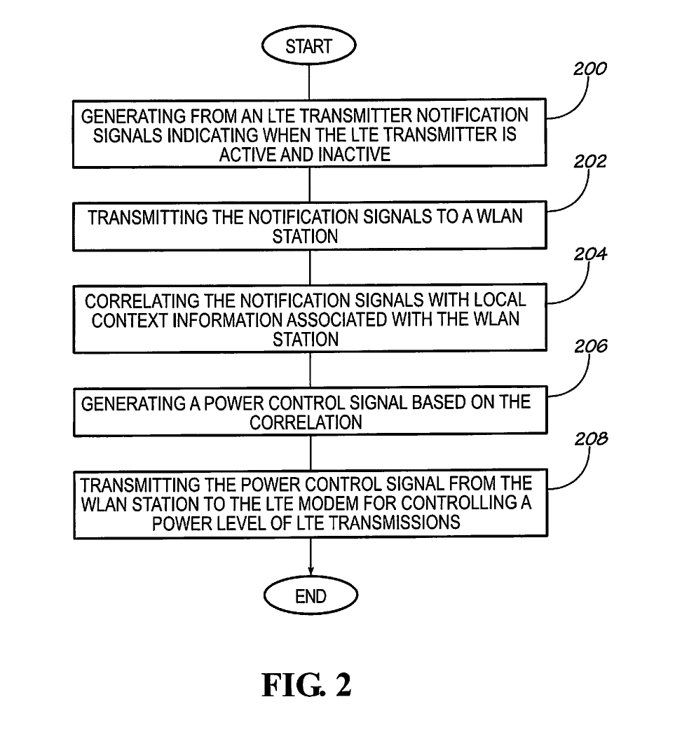

FIG. 2 illustrates a method for mitigating coexistence interference in a UE including the LTE modem 112 and the WLAN station 110, according to an embodiment of the present invention.

At step 200, the LTE transmitter 116 generates notification signals indicating when the LTE transmitter 116 is active and inactive. The notification signals are sent over the CoIs 120, 122 to the IfM block 124 of the WLAN station 110, at step 202.

Thereafter, at step 204 the notification signals are correlated with local context information, e.g., the SNR measurements and the received noise level associated with the WLAN receiver 126, by the IfM 124. The IfM 124 then generates a count information signal which is sent to the CoME 130 of the WLAN station 110.

Next, at step 206, the CoME 130 generates the power control signal, and, at step 208, the power control signal is transmitted to the CoME 114 of the LTE modem for controlling a power level of LTE transmissions.

In embodiments of the present invention, the effect of reducing the power level of the LTE transmitter 114 by 1 dB can be a reduction in the interference level by more than 1 dB. In embodiments, the reduction in interference can be up to 3 dB; such a reduction in power may increase the coexistence efficiency of the collocated WLAN and LTE device 100.

When generating the power control signal, the CoME 114 takes into account such factors as a throughput required by the WLAN station 110, the transmit power level of the LTE transmitter 116, the channel being used for transmitting/receiving, the level of congestion, etc.

When generating the power control signal, the CoME 114 also takes into account such factors as a level of power reduction that can be tolerated by the LTE modem 112, a throughput required by the specific LTE application, a distance to an Evolved Node B (eNodeB), propagation conditions, etc.

The collocated WLAN and LTE device 100 and method of using the same effectively mitigates coexistence interference between the LTE modem 112 and WLAN station 110 without disabling the WLAN station 110 and/or changing WLAN station/LTE channels; this is achieved in an adaptive manner, i.e., reacting to the SNR measurements and the received noise level associated with the WLAN receiver 126.

The present invention can be configured to use fewer PIOs for signaling between the LTE modem 112 and the WLAN station 110 when compared to the aforementioned conventional strategies, making the present invention easier to implement.

The collocated WLAN and LTE device 100 mitigates coexistence interference between the LTE modem 112 and WLAN station 110 while ensuring a level of degradation that is acceptable in the LTE modem 112 and the WLAN station 110; that is, balancing the throughput of the WLAN station 110 by varying the LTE transmit power.

While the present invention has been described herein in terms of LTE interference on WLAN reception, the present invention is equally applicable to WLAN interference on LTE reception. As can be appreciated, certain modifications may have to be made to the present invention in order to accommodate the latter case. For example, the WLAN station 110 may include one or more of the components of the LTE modem 112 used to mitigate coexistence interference, and the LTE modem 112 may include one more of the components of the WLAN station 110 used to mitigate coexistence interference. Additionally, there is a PIO signal, e.g., WLAN Tx, from the WLAN station 110 to the LTE modem 112 that will be present when mitigating WLAN interference on LTE reception. In certain instances both implementations can be used in the same UE.

Although the illustrated embodiment refers to a collocated WLAN and LTE device 100, embodiments are not so limited. In other embodiments, the present invention can be implemented for use with other Wireless Wide Area Network (WWAN) standards and devices, e.g., WLAN BlueTooth (WLANBT), WLAN BlueTooth LowEnergy (WLAN BLE), WiMAX, Global System for Mobile Communications (GSM), 3Q 4G, etc.

Moreover, the present invention can be used with mobile technology other than LTE, e.g., with any radio technologies that transmit discontinuously in adjacent frequency bands.

While the present invention has been particularly shown and described with reference to certain embodiments thereof, it will be understood by those of ordinary skill in the art that various changes in form and details may be made therein without departing from the spirit and scope of the present invention.

What is claimed is:

1. The User Equipment (UE), comprising:
a Long Term Evolution (LTE) modem including a LTE transmitter; and
a Wireless Local Area Network (WLAN) station in communication with the LTE modem via a Coexistence Interface (CoI) which receives notification signals from the LTE modem indicating when the LTE transmitter is active and inactive,
wherein the notification signals and local context information associated with the WLAN station are correlated for generating a power control signal that is transmitted from the WLAN station to the LTE modem for controlling a power level of LTE transmissions.

2. The UE according to claim 1, wherein a Coexistence Management Entity (CoME) of the LTE modem receives the power control signal from a CoME of the WLAN station for determining, based on information provided on the power control signal, the power level of the LTE transmissions.

3. The UE according to claim 2, wherein the CoME of the WLAN station transmits the power control signal periodically.

4. The UE according to claim 2, wherein the WLAN station includes an Interference Measurement (IfM) block, a WLAN modem, and a WLAN receiver.

5. The UE according to claim 4, wherein the IfM block receives Signal-to-Noise Ratio (SNR) measurements from the WLAN modem when packets are received by the WLAN receiver.

6. The UE according to claim 5, wherein the IfM block is configured to measure a received noise level in the WLAN receiver.

7. The UE according to claim 6, wherein the SNR measurements and measured received noise level are part of the local context information associated with the WLAN station and are accumulated in an LTE transmitter active bin and an LTE transmitter inactive bin of the IfM block corresponding to when the LTE transmitter is active and inactive.

8. The UE according to claim 7, wherein packets received by the WLAN receiver when the LTE transmitter transitions from active to inactive are accumulated in a bin of the IfM block that is separate from the LTE transmitter active bin and LTE transmitter inactive bin.

9. The UE according to claim 7, wherein the IfM block generates a count information signal that is based on a calculated interference and the number of packets in the LTE transmitter active bin and the number of packets in the LTE transmitter inactive bin and sends the count information signal to the CoME of the WLAN station for processing.

10. The UE according to claim 7, wherein the local context information associated with the WLAN station further includes a mode in which the WLAN station is operating and packet reception volume.

11. The UE according to claim 1, wherein the CoI is one of a Programmed Input/Output (PIO), and a serial interface.

12. The UE according to claim 2, wherein the CoME of the LTE modem receives the power control signal from the CoME of the WLAN station over a host Access Point (AP).

13. The UE according to claim 2, wherein the CoME of the LTE modem uses the information provided on the power control signal and local context information associated with the LTE modem for calculating the power level of LTE transmissions.

14. The UE according to claim 2, wherein the CoME of the LTE modem sends a power adjust signal to a Power Control Block of the LTE modem for adjusting the power level of LTE transmissions.

15. A method for mitigating coexistence interference in a User Equipment (UE) including a Long Term Evolution (LTE) modem and a Wireless Local Area Network (WLAN) station, the method comprising:
generating from an LTE transmitter of the LTE modem notification signals indicating when the LTE transmitter is active and inactive;
transmitting the notification signals to a WLAN station;
correlating the notification signals with local context information associated with the WLAN station;
generating a power control signal based on the correlation; and
transmitting the power control signal from the WLAN station to the LTE modem for controlling a power level of LTE transmissions.

16. The method of claim 15, wherein transmitting the notification signals to the WLAN station includes transmitting the notification signals from the LTE modem to the WLAN station via a Coexistence Interface (CoI).

17. The method of claim 15, wherein transmitting the notification signals to the WLAN station includes providing information when the LTE transmitter is active and inactive.

18. The method of claim 15, including determining based on information provided on the power control signal the power level of the LTE transmissions.

19. The method of claim 18, wherein the power control signal is transmitted to the CoME of the LTE modem periodically.

20. The method of claim 18, wherein the WLAN station includes an Interference Measurement (IfM) block, a WLAN modem, and a WLAN receiver.

21. The method of claim 20, further comprising:
transmitting, from the WLAN modem to the IfM block, Signal-to-Noise Ratio (SNR) measurements when packets are received by the WLAN receiver;
measuring, with the IfM block, a received noise level in the WLAN receiver; and
accumulating the SNR measurements and measured received noise level in an LTE transmitter active bin and an LTE transmitter inactive bin of the IfM block corresponding to when the LTE transmitter is active and inactive, wherein the SNR measurements and measured received noise level are part of the local context information associated with the WLAN station.

22. The method of claim 21, further comprising:
generating a count information signal that is based on the number of packets in the LTE transmitter active bin and the number of packets in the LTE transmitter inactive bin; and
sending the count information signal to the CoME of the WLAN station for processing.

23. The method of claim 22, wherein the local context information associated with the WLAN station further includes a mode in which the WLAN station is operating and packet reception volume.

24. The method of claim 16, wherein the CoI is one of a Programmed Input/Output (PIO), and a serial interface.

25. The method of claim 18, wherein the CoME of the LTE modem receives the power control signal from the CoME of the WLAN station over a host Access Point (AP).

26. The method of claim 18, further comprising sending a power adjust signal from the CoME of the LTE modem to a Power Control Block of the LTE modem for adjusting the power level of LTE transmissions.

27. A User Equipment (UE), comprising:
a Wireless Local Area Network (WLAN) station including a WLAN modem and a WLAN transreceiver; and
a Long Term Evolution (LTE) modem including an LTE transreceiver, the LTE modem in communication with the WLAN station via a Coexistence Interface (CoI) which receives notification signals from the WLAN modem indicating when the WLAN transreceiver is active and inactive,
wherein the notification signals and local context information associated with one of the LTE modem and the WLAN station are correlated for generating a power control signal that is transmitted from the LTE modem to the WLAN station for controlling a power level of WLAN transmissions.
